(19) United States
(12) Patent Application Publication
(10) Pub. No.: US 2026/0303730 A1
(43) Pub. Date: Oct. 1, 2026

(54) DEVICE MANAGEMENT SYSTEM, DEVICE MANAGEMENT METHOD, AND NON-TRANSITORY COMPUTER-READABLE STORAGE MEDIUM

(71) Applicant: SHARP KABUSHIKI KAISHA, Sakai City (JP)

(72) Inventor: Yuji MIYAKO, Sakai City (JP)

(21) Appl. No.: 19/567,528

(22) Filed: Mar. 16, 2026

(30) Foreign Application Priority Data
Mar. 28, 2025 (JP) 2025-056828

(51) Int. Cl. H04N 1/00

(52) U.S. Cl. CPC H04N 1/00344; H04N 1/00464; H04N 1/00477

(57) ABSTRACT

A device management system includes a relayer that communicates with a device and relays apparatus information relating to the device, a generator that generates, from the apparatus information relayed by the relayer, display information to be displayed by a display, and one or more controllers that issues an update request for the display information in accordance with a relay timing of the apparatus information from the relayer, and causes the display to display the display information being updated.

### FIELD OF THE INVENTION

The disclosure relates to a device management system and the like.

### BACKGROUND ART

There has been known a monitoring control technique in which a device connected to a network is monitored by a management server.

### SUMMARY

### Technical Problem

An object of the disclosure is to provide a device management system and the like that can reduce a load of a management server.

### Solution to Problem

In order to solve the above-mentioned problem, a device management system according to the disclosure includes a relayer that communicates with a device and relays apparatus information relating to the device, a generator that generates, from the apparatus information relayed by the relayer, display information to be displayed by a display, and one or more controllers that issues an update request for the display information in accordance with a relay timing of the apparatus information from the relayer, and causes the display to display the display information being updated.

Further, a device management method according to the disclosure includes communicating with a device and relaying apparatus information relating to the device, generating, from the apparatus information being relayed, display information to be displayed by a display apparatus, and issuing an update request for the display information in accordance with a relay timing of the apparatus information and causing the display apparatus to display the display information being updated.

Further, a device management program according to the disclosure causes a computer to execute a relay function of communicating with a device and relaying apparatus information relating to the device, a generation function of generating, from the apparatus information being relayed, display information to be displayed by a display apparatus, and a control function of issuing an update request for the display information in accordance with a relay timing of the apparatus information and causing the display apparatus to display the display information being updated.

### Advantageous Effects of Disclosure

According to the disclosure, it is possible to provide a device management system and the like that can reduce a load of a management server.

### BRIEF DESCRIPTION OF THE DRAWINGS

FIG. 1 is a block diagram for describing a management system according to a first embodiment.

FIG. 2 is a functional configuration diagram of a multifunction peripheral according to the first embodiment.

FIG. 3 is a diagram for describing an acquisition schedule of apparatus information.

FIG. 4 is a sequence diagram for describing exchange of information in a management system 100.

FIG. 5 is a sequence diagram for describing exchange of information in the management system 100.

FIG. 6 is a diagram for describing an operation example according to the first embodiment.

FIG. 7 is a block diagram for describing a management system according to a second embodiment.

FIG. 8 is a sequence diagram for describing exchange of information in a management system 200.

FIG. 9 is a diagram for describing a device management system in general.

### DESCRIPTION OF EMBODIMENTS

Hereinafter, embodiments of the disclosure are described with reference to the drawings. The embodiments to be described below are merely examples for describing the disclosure, and the technical contents described in the claims are not limited to the following descriptions.

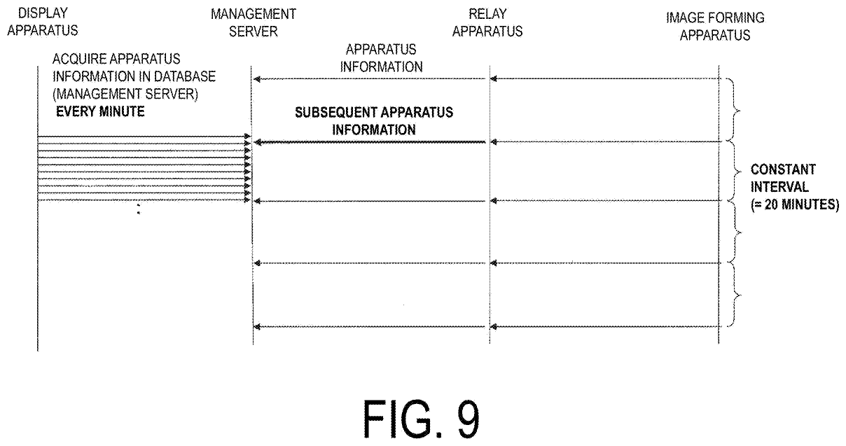

FIG. 9 is a diagram for describing an embodiment of a management system in general. In the management system illustrated in FIG. 9, apparatus information that is output at a constant interval from an image forming apparatus to be managed is transmitted to a management server via a relay apparatus. In the related art, in order to acquire the latest state of the image forming apparatus, a display apparatus that is used as a management apparatus by a user is constantly connected to the management server, and issues, to the management server, an apparatus information update request at a high frequency, for example, every minute.

However, the management server updates apparatus information (display information) based on apparatus information transmitted from the image forming apparatus via the relay apparatus at a constant interval (for example, 20 minutes). Nevertheless, since the management server receives an apparatus information update request at a high frequency from the display apparatus, a large load (network traffic) is constantly imposed on the management server.

The disclosure achieves, in the following embodiments, a device management system that can reduce a load on a management server by issuing a request for acquisition of display information based on apparatus information in accordance with a relay timing of the apparatus information.

### 1 First Embodiment

### 1.1 Functional Configuration

### 1.1.1 Management System 100

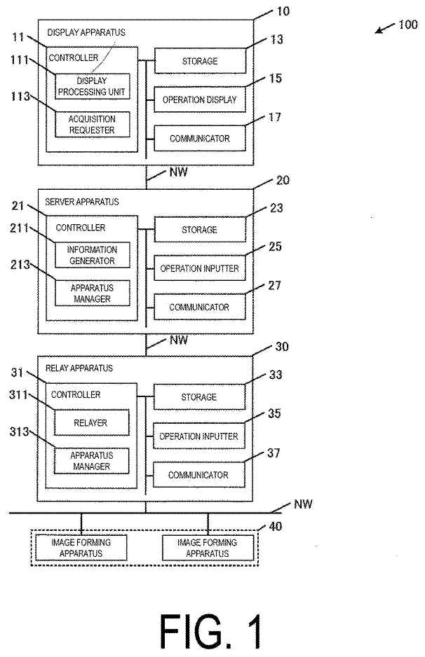

FIG. 1 is a block diagram illustrating a mode of a configuration of a device management system 100 according to the first embodiment in a case where one relay apparatus 30 is provided. The management system 100 is a system that manages an apparatus state of an image forming apparatus 40, which is an example of a device to be managed, by collecting apparatus information relating to the image forming apparatus 40 at each lapse of a predetermined time interval (for example, 20 minutes). In the management system 100, for example, display information that can be displayed on a browser screen is generated based on the apparatus information. A user (administrator) or the like of the image forming apparatus 40 can grasp the apparatus state of the image forming apparatus 40 to be managed, by monitoring a management screen based on the display information displayed on the browser screen.

The management system 100 described above includes a display apparatus 10, a server apparatus 20, the relay apparatus 30, and the image forming apparatus 40, and the respective apparatuses are connected to each other via the network NW so as to perform mutual communication. Note that FIG. 1 illustrates a configuration in which two image forming apparatuses are connected as the image forming apparatuses 40. However, one, three, or more image forming apparatuses 40 to be managed may be provided. In the following description, when there is no need to distinguish the image forming apparatuses from each other, each image forming apparatus may be simply referred to as the image forming apparatus 40. Incidentally, the management system 100 according to the disclosure may be configured as a combination of the display apparatus 10 and the relay apparatus 30, a combination of the server apparatus 20 and the relay apparatus 30, or independent apparatuses of the display apparatus 10, the server apparatus 20, and the relay apparatus 30.

### 1.1.2 Display Apparatus 10

For example, the display apparatus 10 is an information processing apparatus including a display (display apparatus), such as a personal computer, a smartphone, a tablet, and a mobile phone. As illustrated in FIG. 1, the display apparatus 10 includes a controller 11, a storage 13, the operation display 15, and a communicator 17.

The controller 11 generally controls the display apparatus 10. The controller 11 can be configured by one or more arithmetic apparatuses (a central processing unit (CPU), a digital signal processor (DSP), or the like). The controller 11 can function as a display processor 111 and an acquisition requester 113 by reading and executing various programs stored in the storage 13. Note that each function unit included in the controller 11 may be configured as a system on a chip (SoC) including a plurality of functions. Further, the controller 11 may be configured by one or a plurality of control circuits.

Herein, the display processor 111 executes a syntax analysis according to a type of the display information (for example, HTML/XHTML/XML/JSON/CSV, text, image, and the like) received from the server apparatus 20 via the acquisition requester 113, and displays, via a web browser, a user interface (a management screen described later) that is readable and operable by a user. The display processor 111 can be implemented together with the acquisition requester 113 as a browser program.

The acquisition requester 113 issues an acquisition request for the display information with respect to the server apparatus 20 and for a registration time point of the apparatus information relating to the display information. The acquisition requester 113 calculates next and subsequent acquisition time points, based on the received registration time point of the apparatus information. Then, the acquisition requester 113 issues an acquisition request for the display information with respect to the server apparatus 20 at the calculated acquisition time points. The disclosure focuses on the fact that the relay apparatus 30 relays the apparatus information with respect to the server apparatus 20 at a constant interval (a relay timing). Thus, the subsequent update time point is calculated based on the registration time point at which the apparatus information is relayed to and registered in the server apparatus 20, and the acquisition request for the display information with respect to the server apparatus 20 is issued based on the calculated update time point.

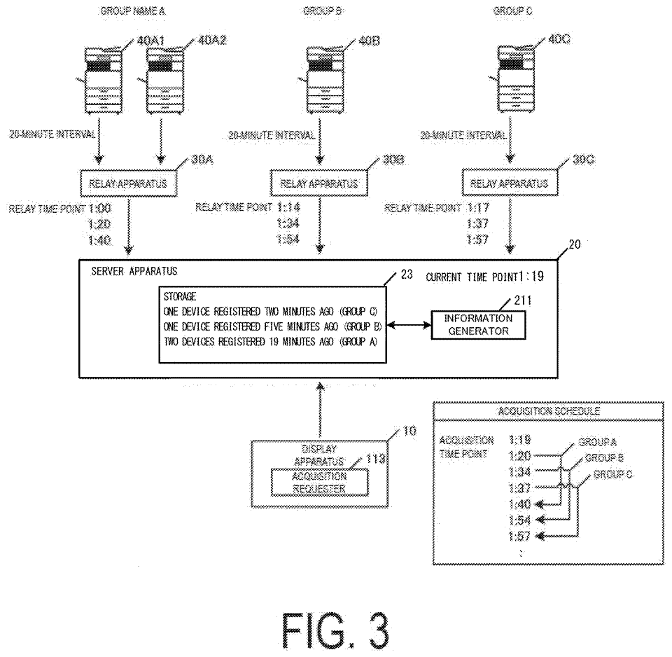

Herein, with reference to FIG. 3, an example of an acquisition schedule of the display information by the acquisition requester 113 is described. Here, description is made on a mode of a group A to which image forming apparatuses 40A1 and 40A2, a relay apparatus 30A, the server apparatus 20, and the display apparatus 10 belong. Note that both the image forming apparatuses 40A1 and 40A2 transmit the apparatus information at the same time point and at the same time interval (a 20-minute interval), based on the acquisition request for the apparatus information from the relay apparatus 30A. Further, the relay timing of the relay apparatus 30A that receives the apparatus information is at a 20-minute interval, and the description is made while assuming that the relay time points are 1:00, 1:20, and 1:40. In addition, the description is made while assuming that the current time point is 1:19.

The relay apparatus 30A relays the apparatus information relating to the image forming apparatuses 40A1 and 40A2 at a relay time point of 1:00, which is 19 minutes before the current time point (1:19), and the storage 23 of the server apparatus 20 is in a state in which the apparatus information relating to the image forming apparatuses 40A1 and 40A2 belonging to the group A is registered 19 minutes before. An information generator 211 generates the display information, based on the received apparatus information relating to the image forming apparatuses 40A1 and 40A2.

The acquisition requester 113 of the display apparatus 10 issues the acquisition request for the display information and the registration time point of the apparatus information relating to the display information with respect to the server apparatus 20 at 1:19, which is the current time point. In this case, the acquisition requester 113 acquires, from the server apparatus 20, the display information relating to the image forming apparatuses 40A1 and 40A2 and 1:00, which is the registration time point of the apparatus information relating to the display information.

Then, the acquisition requester 113 calculates the next and subsequent acquisition time points, based on the acquired registration time point. The relay timing of the relay apparatus 30A is at a 20-minute interval, and hence the acquisition requester 113 calculates the acquisition time points of the apparatus information relating to the group A as 1:20, which is one minute after, and 1:40, which is 20 minutes after 1:20. The acquisition requester 113 issues the acquisition request for the display information relating to the group A at the calculated acquisition time points. The acquisition requester 113 described above can be implemented as a browser program that issues the acquisition request for the display information with respect to the server apparatus 20, based on a request message compliant with, for example, an HTTP/HTTPS communication protocol. In this case, the acquisition requester 113 may update all contents constituting a management screen, based on the received display information, or may update only contents relating to the apparatus information that is changed (updated) by asynchronous communication using, for example, XMLHttpRequest, Ajax, Comet, or the like.

Referring back to FIG. 1, the storage 13 is one or a plurality of storage apparatuses that store required data and store a program. The storage 13 temporarily or non-temporarily stores data and programs for the display apparatus 10. For example, the storage 13 includes a ROM, a RAM, and a storage component.

The ROM is a non-volatile memory capable of holding programs and data even when the power is turned off. The RAM is a main memory mainly used by the controller 11 when executing processing. The RAM is a rewritable memory that temporarily holds a program read out from the ROM or the storage component, data including an execution result, and the like. The storage component is a non-volatile storage apparatus capable of storing programs and data. For example, the storage may be configured with a storage apparatus such as a Hard Disk Drive (HDD) or a Solid State Drive (SSD). Further, the storage component may be configured as a USB memory that can be connected to an external device. In addition, the storage component may be, for example, a storage area on a cloud.

The operation display 15 includes a display configured by a display apparatus such as a liquid crystal display (LCD), an organic electro-luminescence (EL) display, a micro LED display, and a mini LED display, which displays various types of information, and an operator configured by an input apparatus such as a mouse, a keyboard, and a touch panel, which receives operations by a user.

The communicator 17 includes a wired/wireless network communication interface for performing communication compliant with a predetermined communication protocol with the server apparatus 20 via the network NW such as a local area network (LAN), a wide area network (WAN), and the Internet. Note that the wireless network communication interface may include, for example, a short-range wireless communication interface such as Bluetooth (trade name), Wi-Fi (trade name), and IrDA.

### 1.1.3 Server Apparatus 20

As illustrated in FIG. 1, the server apparatus 20 includes a controller 21, a storage 23, an operation inputter 25, and a communicator 27. The server apparatus 20 may be configured as a cloud server, or may be configured as a physical server.

The controller 21 generally controls the server apparatus 20. The controller 21 can be configured by one or more arithmetic apparatuses (a CPU, a DSP, or the like). The controller 21 can function as the information generator 211 and an apparatus manager 213 by reading and executing various programs stored in the storage 23. Note that each function unit included in the controller 21 may be configured as an SoC including a plurality of functions. Further, the controller 21 may be configured by one or a plurality of control circuits.

Herein, the information generator 211 generates the display information for displaying the apparatus information relating to the image forming apparatus 40, which is received from the relay apparatus 30, as contents provided via a web browser of the display apparatus 10, such as an HTML file, a CSS file, a JavaScript file, a text file, and an image file. The information generator 211 can be implemented as a server program that communicates with the display apparatus 10 compliant with an HTTP/HTTPS communication protocol, and transmits the generated display information and the registration time point of the apparatus information relating to the display information to the display apparatus 10 in accordance with the acquisition request received from the display apparatus 10.

The apparatus manager 213 manages the image forming apparatus 40 to be managed and the relay apparatus 30 that relays the apparatus information transmitted from the image forming apparatus 40. For example, the apparatus manager 213 manages apparatus management information in which apparatus identification information for identifying each apparatus and identification information on the network, such as an IP address, are associated with each other. Further, the apparatus manager 213 may also manage the apparatus information relating to the image forming apparatus 40, which is received via the relay apparatus 30, an update state of the apparatus information, and the like.

The storage 23 is one or a plurality of storage apparatuses that store required data and store a program. The storage 23 temporarily or non-temporarily stores data and programs for the server apparatus 20. For example, similarly to the storage 13, the storage 23 includes a ROM, a RAM, and a storage component. The storage 23 stores the apparatus management information managed by the apparatus manager 213, the apparatus information relating to the image forming apparatus 40, which is received via the relay apparatus 30, and the like.

The operation inputter 25 receives an input of an operation from a user or the like or an input of information. For example, the operation inputter 25 can be configured by various input apparatuses such as an operation key including a hardkey and a softkey, and a button. Further, the operation inputter 25 may include a display apparatus such as an LCD, an organic EL display, a micro LED display, and a mini LED display.

The communicator 27 includes a wired/wireless network communication interface for performing communication compliant with a predetermined communication protocol with the one or more display apparatuses 10 and the one or more relay apparatuses 30 via the network NW such as a LAN, a WAN, and the Internet. Note that the wireless network communication interface may include, for example, a short-range wireless communication interface such as Bluetooth (trade name), Wi-Fi (trade name), and IrDA.

### 1.1.4 Relay Apparatus 30

As illustrated in FIG. 1, the relay apparatus 30 includes a controller 31, a storage 33, an operation inputter 35, and a communicator 37. The relay apparatus 30 is arranged between the server apparatus 20 and the one or more image forming apparatuses 40, and relays the apparatus information transmitted from the image forming apparatus 40 to the server apparatus 20 at each lapse of the predetermined time interval.

The controller 31 generally controls the relay apparatus 30. The controller 31 can be configured by one or more arithmetic apparatuses (a CPU, a DSP, or the like). The controller 31 can function as a relayer 311 and an apparatus manager 313 by reading and executing various programs stored in the storage 33. Note that each function unit included in the controller 31 may be configured as an SoC including a plurality of functions. Further, the controller 31 may be configured by one or a plurality of control circuits.

Herein, the relayer 311 relays the apparatus information received from the one or more image forming apparatuses 40 that are connected as management targets, to the server apparatus 20 at each lapse of the predetermined time interval. In such a case, the relayer 311 may establish a secure communication channel with the server apparatus 20, encrypt the received apparatus information, and relay the encrypted apparatus information to the server apparatus 20. The server apparatus 20 may decrypt the encrypted apparatus information and generate the display information. Further, the relayer 311 issues, at a constant interval, the acquisition request for requesting acquisition of the apparatus information with respect to the image forming apparatus 40 to be managed.

The apparatus manager 313 manages the image forming apparatus 40 to be managed. For example, the apparatus manager 213 manages the apparatus management information in which the apparatus identification information for identifying each apparatus and the identification information on the network, such as an IP address, are associated with each other. Further, the apparatus manager 313 may also manage the apparatus information relating to the image forming apparatus 40, an update state of the apparatus information, and the like.

The storage 33 is one or a plurality of storage apparatuses that store required data and store a program. The storage 33 temporarily or non-temporarily stores data and programs for the relay apparatus 30. For example, similarly to the storage 13, the storage 33 includes a ROM, a RAM, and a storage component. The storage 33 stores the apparatus management information managed by the apparatus manager 313, the received apparatus information relating to the image forming apparatus 40, and the like.

The operation inputter 35 receives an input of an operation from a user or the like or an input of information. For example, the operation inputter 35 can be configured by various input apparatuses such as an operation key including a hardkey and a softkey, and a button.

The communicator 37 includes a wired/wireless network communication interface for performing communication compliant with a predetermined communication protocol with the server apparatus 20 and the one or more image forming apparatuses 40 via the network NW such as a LAN, a WAN, and the Internet. Note that the wireless network communication interface may include, for example, a short-range wireless communication interface such as Bluetooth (trade name), Wi-Fi (trade name), and IrDA.

### 1.1.5 Image Forming Apparatus 40

In the disclosure, as the image forming apparatus 40, a multifunction peripheral is described. The multifunction peripheral is an image forming apparatus that can execute jobs relating to copying, scanning, facsimile transmission, e-mail transmission, and the like in a single housing, and can perform, for example, printing an image (a color image or a monochrome image) based on print data received as a print job onto a medium such as paper.

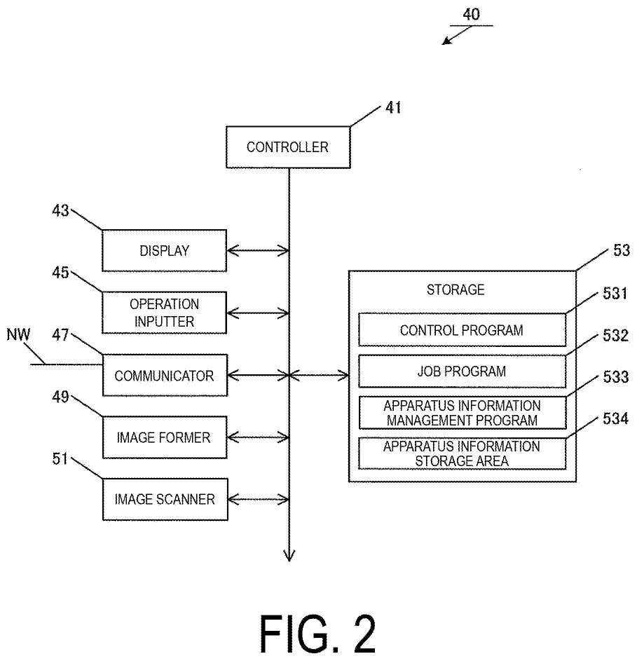

FIG. 2 is a functional configuration diagram of the image forming apparatus 40. The image forming apparatus 40 includes a controller 41, a display 43, an operation inputter 45, a communicator 47, an image former 49, an image reader 51, and a storage 53.

The controller 41 generally controls the image forming apparatus 40. The controller 41 can be configured by one or more arithmetic apparatuses (a CPU, a DSP, or the like). The controller 41 realizes the various functions provided by the image forming apparatus 40 by reading and executing the various programs stored in the storage 53. Note that the controller 41 may be configured as an SoC including a plurality of functions among the functions described below. Further, the controller 41 may be configured by one or a plurality of control circuits.

The display 43 can be configured by a display apparatus that can display various information for a user or the like, such as a liquid crystal display (LCD), an organic electro-luminescence (EL) display, a micro LED display, and a mini LED display.

The operation inputter 45 receives an input of an operation from a user or the like or an input of information. For example, the operation inputter 45 can be configured by various input apparatuses such as an operation key including a hardkey and a softkey, and a button. Further, the operation inputter 45 can also be configured as a touch panel display that enables an input via the display 43. In this case, as the input method of the touch panel display, methods such as a resistive film method, an infrared method, an electromagnetic induction method, and a capacitive method can be employed.

The communicator 47 includes a wired/wireless network communication interface for communicating with the relay apparatus 30 via the network NW such as a LAN, a WAN, the Internet, a telephone line, and a facsimile line. Note that the wireless network communication interface may include, for example, a short-range wireless communication interface such as Bluetooth (trade name), Wi-Fi (trade name), and IrDA.

The image former 49 forms an image based on print data onto a medium such as paper. Paper is fed from a paper feeder (not illustrated), the image former 49 forms an image based on print data onto the paper, and then the paper is discharged to a paper discharger (not illustrated). The image former 49 can be configured by, for example, a laser printer using an electrophotographic system. In this case, the image former 49 performs image formation using toner supplied from a toner cartridge (not illustrated) corresponding to each of toner colors (for example, cyan, magenta, yellow, and black).

The image reader 51 generates scan data by scanning and reading a document image to be read. The image reader 51 can be configured as a scanner apparatus that includes an image sensor such as a charge coupled device (CCD) and a contact image sensor (CIS). The image reader 51 is not limited in its configuration as long as the image reader 51 generates scan data formed of R, G, and B (R: red, G: green, B: blue) analog signals by reading a reflected light image from a document image with the image sensor. Note that the image reader 51 can also be formed as an interface capable of acquiring an image file stored in a storage apparatus such as a USB memory and having a file format such as TIFF, BMP, and JPEG, or image data transmitted from another terminal apparatus such as a personal computer.

The storage 53 is one or a plurality of storage apparatuses that store various programs required for an operation of the image forming apparatus 40 and store various types of data. The storage 53 temporarily or non-temporarily stores data and programs for the image forming apparatus 40. For example, similarly to the storage 13, the storage 53 includes a ROM, a RAM, and a storage component.

The storage 53 according to the disclosure includes a control program 531, a job program 532, and an apparatus information management program 533, and secures an apparatus information storage area 534.

The control program 531 is a program that is read out by the controller 41 when the image forming apparatus 40 is generally controlled. The controller 11 that reads out the control program 531 controls driving of the hardware such as the display 43, the operation inputter 45, the communicator 47, the image former 49, and the image reader 51.

The job program 532 is a program that is read out by the controller 41 when executing various jobs such as a print job, a copy job, a scan job, a facsimile job, and an e-mail transmission job. The controller 41 that reads out the job program 532 switches an apparatus mode of the image forming apparatus 40 to a job mode for executing each job, and executes a job for which an execution instruction is received.

The apparatus information management program 533 is a program that is read out by the controller 41 when the apparatus information relating to the image forming apparatus 40 is managed. For example, the controller 41 that reads out the apparatus information management program 533 manages the apparatus information such as identification information for identifying the apparatus, user information, consumable information such as a remaining amount of toner, and a status information relating to the apparatus (an operation state, or a connection state with respect to the management system 100), and transmits the apparatus information to the relay apparatus 30, based on the acquisition request for the apparatus information from the relay apparatus 30.

The apparatus information storage area 534 is a storage area that stores the apparatus information managed by the controller 41 that reads out the apparatus information management program 533.

### 1.2 Exchange of Information in Management System 100

1.2.1 Configuration in which One Relay Apparatus 30 and One Image Forming Apparatus 40 are Provided

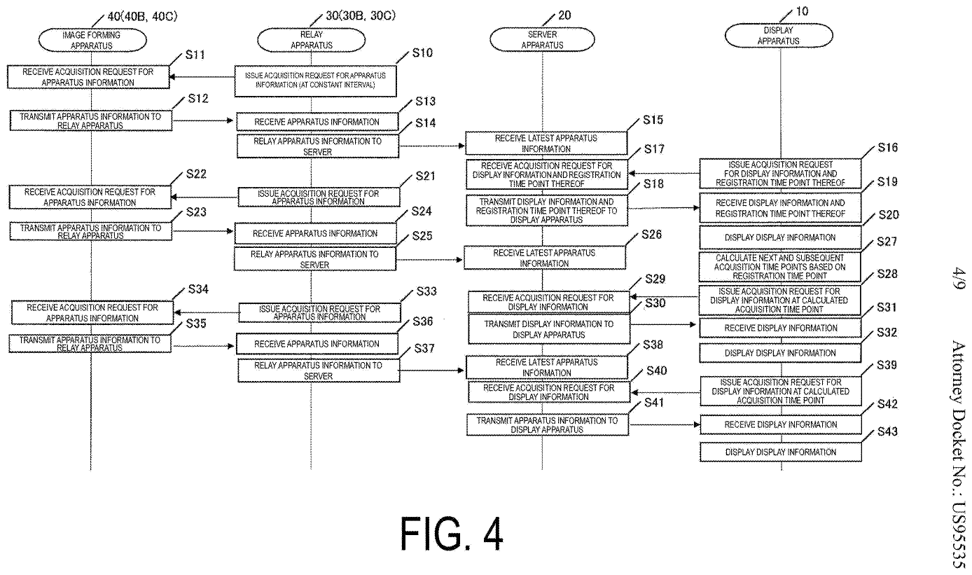

Next, exchange of information in the management system 100 is described. FIG. 4 is a sequence diagram for describing exchange of information in a configuration in which one relay apparatus 30 and one image forming apparatus 40 are provided. FIG. 4 shows an example in which the image forming apparatus 40 corresponds to an image forming apparatus 40B and the relay apparatus 30 corresponds to a relay apparatus 30B (a group B), or an example in which the image forming apparatus 40 corresponds to an image forming apparatus 40C and the relay apparatus 30 corresponds to a relay apparatus 30C (a group C), which are illustrated in FIG. 3.

The relay apparatus 30 issues the acquisition request for the apparatus information with respect to the image forming apparatus 40 (at a constant interval) (S10). Note that the relay apparatus 30 may issue the acquisition request for the apparatus information with respect to the image forming apparatus 40 at a time interval within the time interval between the relay timings with respect to the server apparatus 20, or may issue the acquisition request for the apparatus information at the same time interval as that between the relay timings.

The image forming apparatus 40 receives the acquisition request for the apparatus information from the relay apparatus 30 (S11). When the acquisition request for the apparatus information is received, the image forming apparatus 40 transmits the apparatus information to the relay apparatus 30 (S12).

When the apparatus information is received from the image forming apparatus 40 (S13), the relay apparatus 30 relays the received apparatus information to the server apparatus 20 (S14).

The server apparatus 20 receives the apparatus information relayed from the relay apparatus 30 as the latest apparatus information (S15). The server apparatus 20 generates the display information, based on the received apparatus information.

Incidentally, the display apparatus 10 issues the acquisition request for the display information and the registration time point thereof with respect to the server apparatus 20 (S16).

The server apparatus 20 receives the acquisition request for the display information and the registration time point thereof from the display apparatus 10 (S17). The server apparatus 20 transmits the display information and the registration time point thereof to the display apparatus 10 in response to the acquisition request from the display apparatus 10 (S18).

The display apparatus 10 receives the display information and the registration time point thereof from the server apparatus 20 (S19), and displays the received display information (management screen) (S20). For example, in a case of the group B illustrated in FIG. 3, the display apparatus 10 receives a time point of 1:14 as the registration time point of the apparatus information.

Meanwhile, the relay apparatus 30 issues the acquisition request for the apparatus information with respect to the image forming apparatus 40 (S21).

The image forming apparatus 40 receives the acquisition request for the apparatus information from the relay apparatus 30 (S22). When the acquisition request for the apparatus information is received, the image forming apparatus 40 transmits the apparatus information to the relay apparatus 30 (S23).

When the apparatus information is received from the image forming apparatus 40 (S24), the relay apparatus 30 relays the received apparatus information to the server apparatus 20 (S25).

The server apparatus 20 receives the apparatus information relayed from the relay apparatus 30 as the latest apparatus information (S26). The server apparatus 20 generates the display information, based on the received apparatus information.

Incidentally, the display apparatus 10 calculates the next and subsequent acquisition time points, based on the registration time point received in S19 (S27). For example, in a case of the group B illustrated in FIG. 3, the display apparatus 10 receives time points of 1:34 and 1:54 as the next and subsequent acquisition time points of the apparatus information. Then, the display apparatus 10 issues the acquisition request for the display information with respect to the server apparatus 20 at the calculated acquisition time point (1:34) (S28).

The server apparatus 20 receives the acquisition request for the display information from the display apparatus 10 (S29). The server apparatus 20 transmits the display information to the display apparatus 10 in response to the acquisition request from the display apparatus 10 (S30).

The display apparatus 10 receives the display information from the server apparatus 20 (S31), and displays the received display information (management screen) (S32).

Subsequently, the relay apparatus 30 issues the acquisition request for the apparatus information with respect to the image forming apparatus 40 (S33).

The image forming apparatus 40 receives the acquisition request for the apparatus information from the relay apparatus 30 (S34). When the acquisition request for the apparatus information is received, the image forming apparatus 40 transmits the apparatus information to the relay apparatus 30 (S35).

When the apparatus information is received from the image forming apparatus 40 (S36), the relay apparatus 30 relays the received apparatus information to the server apparatus 20 (S37).

The server apparatus 20 receives the apparatus information relayed from the relay apparatus 30 as the latest apparatus information (S38). The server apparatus 20 generates the display information, based on the received apparatus information.

Incidentally, the display apparatus 10 issues the acquisition request for the display information with respect to the server apparatus 20 at the acquisition time point calculated in S27 (1:54) (S39).

The server apparatus 20 receives the acquisition request for the display information from the display apparatus 10 (S40). The server apparatus 20 transmits the display information to the display apparatus 10 in response to the acquisition request from the display apparatus 10 (S41).

The display apparatus 10 receives the display information from the server apparatus 20 (S42), and displays the received display information (management screen) (S43).

1.2.2 Configuration in which One Relay Apparatus 30 and Two Image Forming Apparatus 40 are Provided

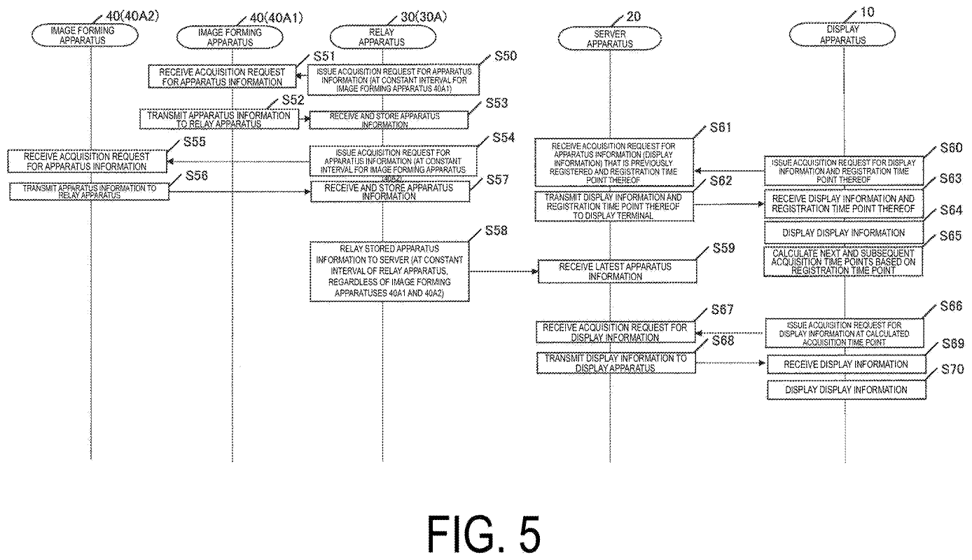

FIG. 5 is a sequence diagram for describing exchange of information in a configuration in which one relay apparatus 30 and two image forming apparatuses 40 are provided. FIG. 5 shows an example of the group A in which the image forming apparatuses 40 correspond to the image forming apparatuses 40A1 and 40A2 and the relay apparatus 30 corresponds to the relay apparatus 30A, which are illustrated in FIG. 3.

The relay apparatus 30A issues the acquisition request for the apparatus information at an interval used for the image forming apparatus 40A1 (S50).

The image forming apparatus 40A1 receives the acquisition request for the apparatus information from the relay apparatus 30A (S51). When the acquisition request is received, the image forming apparatus 40A1 transmits the apparatus information to the relay apparatus 30A (S52).

The relay apparatus 30A receives the apparatus information from the image forming apparatus 40A1, and stores the apparatus information (S53). Then, the relay apparatus 30A issues the acquisition request for the apparatus information at an interval for the image forming apparatus 40A2 (S54).

The image forming apparatus 40A2 receives the acquisition request for the apparatus information from the relay apparatus 30A (S55). When the acquisition request is received, the image forming apparatus 40A2 transmits the apparatus information to the relay apparatus 30A (S56)

The relay apparatus 30A receives the apparatus information from the image forming apparatus 40A2 and stores the apparatus information (S57). Subsequently, the relay apparatus 30A relays the apparatus information relating to the image forming apparatuses 40A1 and 40A2 collectively to the server apparatus 20 at the relay timing with respect to the server apparatus 20, regardless of the acquisition timings of the apparatus information from the plurality of devices, specifically, the image forming apparatuses 40A1 and 40A2 (S58).

Incidentally, the display apparatus 10 issues the acquisition request for the display information and the registration time point thereof with respect to the server apparatus 20 (S60).

The server apparatus 20 receives the acquisition request for the apparatus information (the display information) that is registered in advance and the registration time point thereof from the display apparatus 10 (S61). The server apparatus 20 transmits the display information and the registration time point thereof to the display apparatus 10 in response to the acquisition request from the display apparatus 10 (S62).

The display apparatus 10 receives the display information and the registration time point thereof from the server apparatus 20 (S63), and displays the received display information (management screen) (S64). For example, in a case of the group A illustrated in FIG. 3, the display apparatus 10 receives a time point of 1:00 as the registration time point of the apparatus information.

The display apparatus 10 calculates the next and subsequent acquisition time points, based on the registration time point received in S63 (S65). For example, in a case of the group A illustrated in FIG. 3, the display apparatus 10 calculates time points of 1:20 and 1:40 as the next and subsequent acquisition time points of the apparatus information. Then, the display apparatus 10 issues the acquisition request for the display information with respect to the server apparatus 20 at the calculated acquisition time point (1:20) (S66).

The server apparatus 20 receives the acquisition request for the display information from the display apparatus 10 (S67). The server apparatus 20 transmits the display information to the display apparatus 10 in response to the acquisition request from the display apparatus 10 (S68).

The display apparatus 10 receives the display information from the server apparatus 20 (S69), and displays the received display information (management screen) (S70).

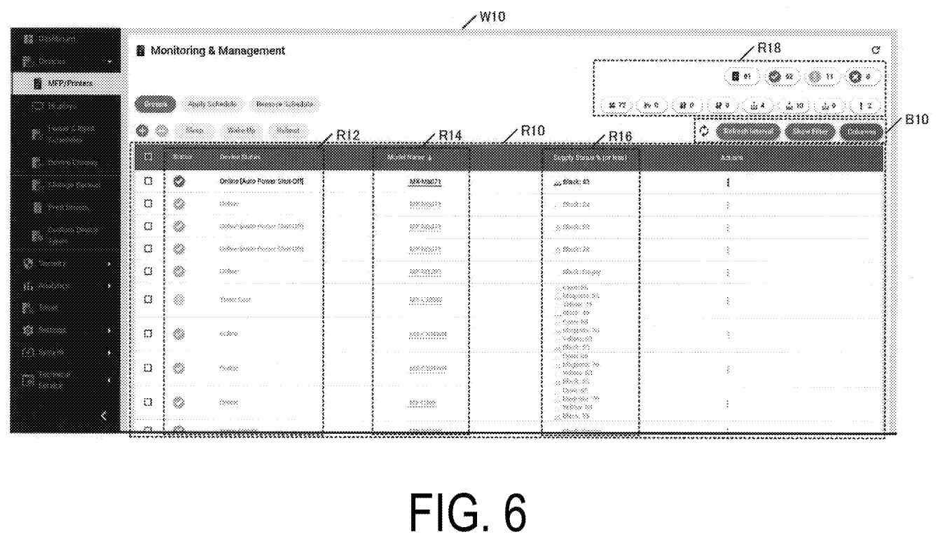

Next, an operation example according to the first embodiment is described with reference to FIG. 6. FIG. 6 is a diagram for describing an example of a display configuration of a management screen W10 that is displayed by the display apparatus 10, based on the display information received the server apparatus 20 via the relay apparatus 30.

The management screen W10 includes a management target display region R10, a function button B10, and a status display region R18.

The management target display region R10 is a display region where the image forming apparatuses 40 managed in the management system 100 are displayed (in a list). The management target display region R10 includes an individual status region R12, a model name display region R14, and a toner remaining amount display region R16. The individual status region R12 is a display region where a status of the image forming apparatus 40 to be managed is individually displayed. As illustrated in FIG. 6, in the individual status region R12, the status of the image forming apparatus 40 can be indicated by a symbol (Status) or a simple status description (Device Status). In FIG. 6, as an operation status of the image forming apparatus 40, an operable state is indicated by a check mark, a case where there is a notification to a user (administrator) is indicated by an information mark, and an inoperable state is indicated by a cross mark. In the model name display region R14, a model name of the image forming apparatus 40 to be managed is displayed. In the toner remaining amount display region R16, a toner remaining amount of the image forming apparatus 40 to be managed is displayed.

For example, the image forming apparatus 40 shown in the uppermost row of the management target display region R10 indicates that an operation status is an operable state (a check mark), while an apparatus state is an automatic power-off state (Online [Auto Power Shut-Off]). Further, it is indicated that the model name of the image forming apparatus 40 is MX-M6071 and a toner remaining amount (black) is 43%. Note that, in FIG. 6, a mode in which the remaining amount of toner is displayed is described as an example of the apparatus state of the image forming apparatus 40. However, in addition to the remaining amount of toner, other consumable information such as a remaining amount of printable paper, or hardware information relating to a lifetime of an image forming unit, a fixing unit, or the like, may be displayed.

The function button B10 is a button group that receives an operation instruction from a user (administrator). FIG. 6 illustrates an example in which a Refresh Interval button for receiving a manual screen update instruction for the management target display region R10, a Show Filter button for receiving a selection instruction of filter processing for the image forming apparatuses 40 displayed in the management target display region R10, and a Columns button for receiving a selection instruction of the number of image forming apparatuses 40 (the number of columns) to be displayed in the management target display region R10 are provided.

The status display region R18 is a display region where aggregated results of operation statuses of all the image forming apparatuses 40 to be managed are displayed. FIG. 6 illustrates an example indicating that a total of 81 image forming apparatuses 40 to be managed exist, among which 62 image forming apparatuses 40 are in an operable state, 11 image forming apparatuses 40 have a notification to a user (administrator), and 8 image forming apparatuses 40 are in an inoperable state, in terms of the operation status.

As described above, according to the first embodiment, the acquisition request for the apparatus information (the display information) is issued in accordance with the relay timing of the apparatus information by the relay apparatus with respect to the management server. Thus, the display apparatus is not required to be connected constantly to the management server or issue, to the management server, an update request for the apparatus information at a high frequency, for example, every minute. As a result, a load on the management server can be reduced.

### 2 Second Embodiment

### 2.1 Functional Configuration

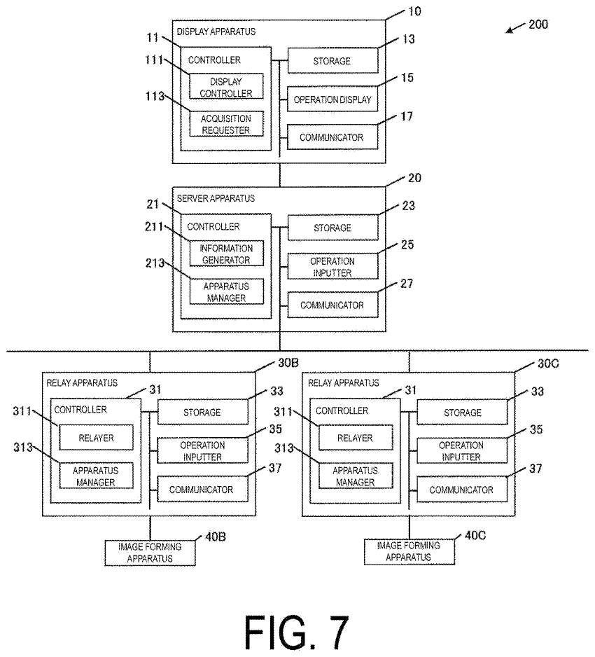

FIG. 7 is a diagram for describing a mode of a configuration of a management system 200 according to a second embodiment, and is a block diagram of a case where two relay apparatuses 30 (30B and 30C) are provided, the management system 200 illustrated in FIG. 7 can be configured substantially the same as the management system 100 according to the first embodiment, except that the number of the relay apparatuses 30 is increased to two. Thus, the same configurations are denoted with the same reference symbols, and the description thereof is omitted. Note that the block diagram illustrated in FIG. 6 is equivalent to a configuration including both the group B and the group C of FIG. 3.

### 2.2 Exchange of Information in Management System 200

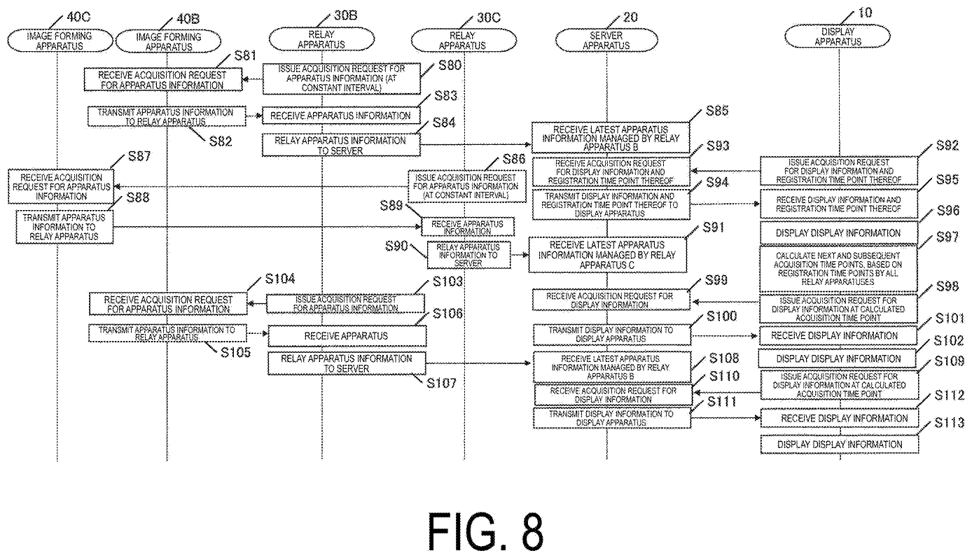

Next, exchange of information in the management system 200 is described. FIG. 8 is a sequence diagram for describing exchange of information in a configuration in which the two relay apparatuses 30B and 30C are provided.

The relay apparatus 30B issues the acquisition request for the apparatus information with respect to the image forming apparatus 40B (at a constant interval) (S80).

The image forming apparatus 40B receives the acquisition request for the apparatus information from the relay apparatus 30B (S81). When the acquisition request is received, the image forming apparatus 40B transmits the apparatus information to the relay apparatus 30B (S82).

When the apparatus information is received from the image forming apparatus 40B (S83), the relay apparatus 30B relays the received apparatus information to the server apparatus 20 (S84).

The server apparatus 20 receives the apparatus information relayed by the relay apparatus 30B as the latest apparatus information (S85). The server apparatus 20 generates the display information, based on the received apparatus information.

Meanwhile, the relay apparatus 30C issues the acquisition request for the apparatus information with respect to the image forming apparatus 40C (at a constant interval) (S86).

The image forming apparatus 40C receives the acquisition request for the apparatus information from the relay apparatus 30C (S87). When the acquisition request is received, the image forming apparatus 40C transmits the apparatus information to the relay apparatus 30C (S88).

When the apparatus information is received from the image forming apparatus 40C (S89), the relay apparatus 30C relays the received apparatus information to the server apparatus 20 (S90).

The server apparatus 20 receives the apparatus information relayed by the relay apparatus 30C as the latest apparatus information (S91). The server apparatus 20 generates the display information, based on the received apparatus information.

Incidentally, the display apparatus 10 issues the acquisition request for all the display information managed for the respective relay apparatuses 30 as the plurality of relayers and the registration time points thereof with respect to the server apparatus 20 (S92).

The server apparatus 20 receives the acquisition request for the display information and the registration time points thereof from the display apparatus 10 (S93). The server apparatus 20 transmits the display information and the registration time points thereof to the display apparatus 10 in response to the acquisition request from the display apparatus 10 (S94).

The display apparatus 10 receives the display information and the registration time points thereof from the server apparatus 20 (S95), and displays the received display information (management screen) (S96). Then, the display apparatus 10 calculates the next and subsequent acquisition time points, based on the registration time points (the relay timings) by the relay apparatuses 30B and 30C (S97). Then, the display apparatus 10 issues the acquisition request for the display information with respect to the server apparatus 20 at the calculated acquisition time points (S98).

The server apparatus 20 receives the acquisition request for the display information from the display apparatus 10 (S99). The server apparatus 20 transmits all the pieces of the display information being managed to the display apparatus 10, in response to the acquisition request from the display apparatus 10 (S100).

The display apparatus 10 receives the display information from the server apparatus 20 (S101), and displays the received display information (management screen) (S102).

Incidentally, the relay apparatus 30B issues the acquisition request for the apparatus information with respect to the image forming apparatus 40B (S103).

The image forming apparatus 40B receives the acquisition request for the apparatus information from the relay apparatus 30B (S104). When the acquisition request is received, the image forming apparatus 40B transmits the apparatus information to the relay apparatus 30B (S105).

When the apparatus information is received from the image forming apparatus 40B (S106), the relay apparatus 30B relays the received apparatus information to the server apparatus 20 (S107).

The server apparatus 20 receives the apparatus information relayed by the relay apparatus 30B as the latest apparatus information (S108). The server apparatus 20 generates the display information, based on the received apparatus information.

Incidentally, the display apparatus 10 issues the acquisition request for the display information with respect to the server apparatus 20 at the acquisition time points calculated in S97 (S109).

The server apparatus 20 receives the acquisition request for the display information from the display apparatus 10 (S110). The server apparatus 20 transmits all the pieces of the display information being managed to the display apparatus 10, in response to the acquisition request from the display apparatus 10 (S111).

The display apparatus 10 receives the display information from the server apparatus 20 (S112), and displays the received display information (management screen) (S113).

As described above, in the second embodiment, in the management system 200 in which the plurality of relay apparatuses 30 are provided, the next and subsequent acquisition time points are calculated based on all the registration time points of the apparatus information relating to the respective relay apparatuses managed by the server apparatus 20, and the acquisition request for the apparatus information is issued at the acquisition time points. Thus, the display apparatus 10 is not required to be connected constantly to the management server or issue, to the management server, an update request for the apparatus information at a high frequency, for example, every minute. Therefore, according to the second embodiment, a load on the management server can be reduced similarly to the first embodiment.

### 3 Third Embodiment

A third embodiment is a mode in which, when a predetermined number or more of the relay apparatuses 30 are provided, the acquisition request for the display information with respect to the server apparatus 20 is issued without calculating the next and subsequent acquisition time points based on the registration time points (the relay timings) by the relay apparatus 30.

In the first embodiment, description is made on the ode in which one or two relay apparatuses 30 are provided. For example, it is assumed that a time period required for relaying the apparatus information by each relay apparatus 30 is one minute. When the relay timing of the relay apparatus 30 is at a 20-minute interval, a total of 20 relay apparatuses 30 can be allocated per minute.

However, hypothetically, when 100 relay apparatuses 30 are provided, it is required to relay the apparatus information to the server apparatus 20 100 times between the relay timings (20 minutes). Thus, a high load is applied to the server apparatus 20.

In the third embodiment, when the number of the relay apparatuses 30 is equal to or greater than a predetermined number, for example, 20 or greater, the acquisition request for the display information with respect to the server apparatus 20 is issue every minute without calculating the next and subsequent acquisition time points based on the registration time points (the relay timings) by the relay apparatus 30.

As described above, according to the third embodiment, when the number of the relay apparatuses is equal to or greater than a predetermined number, the acquisition request for the display information is issued with respect to the server apparatus every minute without calculating the next and subsequent acquisition time points based on the registration time points (the relay timings) by the relay apparatuses. With this, it is possible to provide a management system that is more flexible and user-friendly.

The disclosure is not limited to the embodiments described above and can be modified in various ways. That is, embodiments obtained by appropriately combining technical means within the scope not departing from the gist of the disclosure are also included within the technical scope of the disclosure.

Further, although the above-described embodiments are described separately for convenience of description, it is obvious that the embodiments may be executed in combination within a technically possible scope.

Further, in the embodiments, a program operating on each apparatus is a program that controls a CPU or the like (a program for causing a computer to function) to realize the functions of the above-described embodiments. Information handled by such an apparatus is temporarily stored in a temporary storage apparatus (for example, a RAM) during the processing and then stored in various storage apparatuses such as read only memories (ROMs) and HDDs, and is read, modified, and written by the CPU as necessary.

Herein, a computer-readable non-transitory recording medium on which a program is recorded in an information processing apparatus may be any of a semiconductor medium (for example, a ROM or a non-volatile memory card), an optical recording medium/magnetic optical recording medium (for example, a digital versatile disc (DVD), magneto optical disc (MO), mini disc (MD), compact disc (CD), or Blu-ray (BD; trade name) disc)), a magnetic recording medium (for example, a magnetic tape or flexible disk), and the like. In this case, the program recorded on the recording medium is read by the computer of the information processing apparatus and executed by the computer, such that not only the functions of the above-described embodiment are enabled, but also functions of the disclosure are enabled by performing processing in cooperation with an operating system, another application program, or the like based on instructions of the program.

Further, when a program is distributed in a market, the program can be stored in a portable recording medium and distributed, or can be transferred to a server computer connected via a network such as the Internet. In this case, it is obvious that a storage apparatus of the server computer is also included in the disclosure.

Further, each functional block or feature of the apparatus used in the above-described embodiment can also be implemented and executed by an electric circuit, such as an integrated circuit or a plurality of integrated circuits. The electric circuit designed to enable the functions described herein may include a general-purpose processor, a Digital Signal Processor (DSP), an Application-Specific Integrated Circuit (ASIC), a Field Programmable Gate Array (FPGA), another programmable logic device, a discrete gate or transistor logic, a discrete hardware component, or a combination thereof. The general-purpose processor may be a microprocessor or may be a known processor, controller, microcontroller, or state machine. The electric circuit described above may include a digital circuit or may include an analog circuit. Further, when an integrated circuit technology for replacement into a current integrated circuit emerges with the development of semiconductor technology, a new integrated circuit based on the technology may also be used in one or more aspects of the disclosure.

### REFERENCE SIGNS LIST

10 Display apparatus
11 Controller
111 Display processor
113 Acquisition requester
13 Storage
15 Operation display
17 Communicator
20 Server apparatus
21 Controller
211 Information generator
213 Apparatus manager
23 Storage
25 Operation inputter
27 Communicator
30 Relay apparatus
31 Controller
311 Relayer
313 Apparatus manager
33 Storage
35 Operation inputter
37 Communicator
40 Image forming apparatus
41 Controller
43 Display
45 Operation inputter
47 Communicator
49 Image former
51 Image reader
53 Storage
531 Control program
533 Job program
535 Apparatus information management program
534 Apparatus information storage area
100, 200 Management system

1. A device management system comprising:
a relayer that communicates with a device and relays apparatus information relating to the device;
a generator that generates, from the apparatus information relayed by the relayer, display information to be displayed by a display; and
one or more controllers that issues an update request for the display information in accordance with a relay timing of the apparatus information from the relayer, and causes the display to display the display information being updated.

2. The device management system according to claim 1, wherein
the relayer relays the apparatus information at each lapse of a predetermined time interval as the relay timing.

3. The device management system according to claim 2, wherein
when the apparatus information is acquired from a plurality of devices at different acquisition timings, the relayer relays the apparatus information collectively at the relay timing.

4. The device management system according to claim 2, further comprising:
a plurality of relayers that communicate with a plurality of devices, wherein
the one or more controllers calculate the relay timing for each of the plurality of relayers, and issues the update request.

5. The device management system according to claim 4, wherein
when the number of the relayers is equal to or greater than a predetermined number, the one or more controllers issues the update request without calculating the relay timing.

6. A device management method comprising:
communicating with a device and relaying apparatus information relating to the device;
generating, from the apparatus information being relayed, display information to be displayed by a display apparatus; and
issuing an update request for the display information in accordance with a relay timing of the apparatus information and causing the display apparatus to display the display information being updated.

7. A non-transitory computer-readable storage medium storing a program for causing a computer to execute processing comprising:
communicating with a device and relaying apparatus information relating to the device;
generating, from the apparatus information being relayed, display information to be displayed by a display apparatus; and
issuing an update request for the display information in accordance with a relay timing of the apparatus information and causing the display apparatus to display the display information being updated.
